(19) United States
(12) Patent Application Publication
(10) Pub. No.: US 2023/0082218 A1
(43) Pub. Date: Mar. 16, 2023

(54) METHOD AND SYSTEM FOR ANALYZING REGIONAL ENERGY INTERNET LOAD BEHAVIOR BASED ON RANDOM MATRIX

(71) Applicant: SHANDONG UNIVERSITY, Jinan (CN)

(72) Inventors: Tianguang LV, Jinan (CN); Yixiao LI, Jinan (CN); Wenbo LI, Jinan (CN); Donglei SUN, Jinan (CN); Xueqian HE, Jinan (CN); Qian AI, Jinan (CN); Shumin SUN, Jinan (CN)

(73) Assignee: SHANDONG UNIVERSITY, Jinan (CN)

(21) Appl. No.: 17/749,994

(22) Filed: May 20, 2022

(30) Foreign Application Priority Data
Sep. 15, 2021 (CN) 2021110790637

(51) Int. Cl. G06F 17/14; G06F 17/16; G06F 17/18

(52) U.S. Cl. CPC G06F 17/14; G06F 17/16; G06F 17/18

(57) ABSTRACT

A method and system for analyzing a regional energy Internet load behavior based on a random matrix. Obtaining a coupled meteorological factor index according to acquired meteorological data; obtaining an influence factor matrix according to coupled meteorological index data; obtaining a basic state matrix according to active load data; obtaining an augmented data source matrix according to the basic state matrix and the influence factor matrix, and obtaining a Pearson correlation coefficient matrix by calculating Pearson correlation coefficients of the coupled meteorological factor index and the active load data; obtaining a source matrix according to the matrices; obtaining the random matrix after performing matrix transformation on the source matrix; obtaining probability density distribution after performing spectrum analysis on characteristic values of the random matrix, and obtaining an abnormality recognition result of the active load data according to comparison between the probability density distribution and historical probability density distribution.

### TECHNICAL FIELD

The present application relates to the technical field of power active load data analysis, and particularly relates to a method and system for analyzing a regional energy internet load behavior based on a random matrix.

### BACKGROUND

The statements in this section merely provide background related to the present application and do not necessarily constitute the prior art.

At present, non-traditional main units have been gradually industrialized and applied to power grids. The power system is regarded as a typical big data system, which continuously generates massive, heterogeneous, real-time, and real data. The state of the power system is susceptible to a variety of external factors, and the consumption behavior of power users is complicated and changeable. Therefore, taking the behavior of the power users into full consideration and stimulating the users' subjective initiative to realize the transition from passive load to active load is of great significance to the construction of modern power grids.

The inventors found that currently the load forecasting and load abnormality data recognition of the power grid mostly rely on traditional physical modeling methods, which cannot cope with the increasing complexity of power grids and cannot meet the requirements of real-time analysis and accuracy. Singular scattered meteorological factors (such as wind speed, wind direction, sunshine intensity and time, rainfall, atmospheric pressure and other meteorological factors which are independent) alone cannot reveal the correspondence with the power active load, leading to a low accuracy in recognizing abnormal data of the power active load. During the recognition of the abnormal data of the power active load, if data measured by a power grid measurement terminal is directly introduced and transformed into a random matrix, abnormality of single or single-batch data of the power grid is prone to the occurrence of state recognition omission or misrecognition.

### SUMMARY

In order to overcomes the defects in the prior art, the present application provides a method and system for analyzing a regional energy Internet load behavior based on a random matrix, and improves the accuracy of abnormal data recognition of an active load.

To achieve the foregoing objective, the present application uses the following technical solutions.

In the first aspect, the present application provides a method for analyzing a regional energy Internet load behavior based on a random matrix.

The method for analyzing the regional energy Internet load behavior based on the random matrix comprises the following process:

acquiring meteorological data and active load data of a region to be analyzed;

obtaining a coupled meteorological factor index according to the acquired meteorological data:

obtaining an influence factor matrix according to coupled meteorological index data;

obtaining a basic state matrix according to the active load data:

obtaining an augmented data source matrix according to the basic state matrix and the influence factor matrix;

obtaining a Pearson correlation coefficient matrix by calculating Pearson correlation coefficients of the coupled meteorological factor index and the active load data in the augmented data source matrix;

obtaining a source matrix according to the Pearson correlation coefficient matrix and the basic state matrix;

obtaining the random matrix after performing matrix transformation on the source matrix; and

obtaining probability density distribution after performing spectrum analysis on characteristic values of the random matrix, and obtaining an abnormality recognition result of the active load data according to comparison between the probability density distribution and historical probability density distribution in a normal state.

Further, calculating the Pearson correlation coefficients of the coupled meteorological factor index and the active load data comprises:

selecting a sub-matrix from the augmented data source matrix by moving a window, and calculating the Pearson correlation coefficient by using data of a certain row of the basic state matrix and a corresponding row of the influence factor matrix.

Further, the matrix transformation comprises the following process:

acquiring a source matrix at a certain sampling moment;

transforming the source matrix into a standard non-Hermitian matrix;

according to the obtained standard non-Hermitian matrix, calculating singular value equivalent matrices;

multiplying the plurality of obtained singular value equivalent matrices to obtain a matrix to be analyzed;

converting the matrix to be analyzed into a standard matrix with a mean value of 1 and a variance of 0; and

using a covariance matrix of the standard matrix as a finally transformed matrix.

Furthermore, calculating characteristic values of the matrix after matrix transformation;

performing spectrum analysis according to the obtained characteristic values;

obtaining probability density distribution of the Pearson correlation coefficient according to spectrum analysis results; and

obtaining a correspondence between the coupled meteorological factor index and an active load according to the probability density distribution of the Pearson correlation coefficient.

Further, the coupled meteorological factor index at least includes a heat index (HI):

HI=c₁+c₂T+c₃R+c₄TR+c₅T²+c₆R²+c₇T²R+c₈TR²+c₉T²R²,

wherein c₁, c₂, c₃, c₄, c₅, c₆, c₇, c₈ and c₉ are constant coefficients, T is temperature and R is relative humidity.

Further, the coupled meteorological factor index at least includes an effective temperature Tₑ:

$${T}_{e} = 37 - \frac{( 37 - {T}_{a} )}{[ 0.68 - 0.14 {R}_{h} + 1 / 1.76 + 1.4 {V}^{0.75} ) ]} - 0.29 {T}_{a} ( 1 - {R}_{h} ) ,$$

wherein Tₐ is an air temperature, Rₕ is the relative humidity, and V is a wind speed.

Further, the coupled meteorological factor index at least includes a human body comfort index k:

k=1.8Tₐ−0.55(1.8Tₐ−26)(1−Rₕ)−3.21\sqrt{V}+3.2,

wherein Tₐ is an air temperature, Rₕ is the relative humidity, and V is a wind speed.

In the second aspect, the present application provides a system for analyzing a regional energy Internet load behavior based on a random matrix.

The system for analyzing the regional energy Internet load behavior based on the random matrix comprises:

a data acquiring module, configured to acquire meteorological data and active load data of a region to be analyzed;

a coupled meteorological index acquiring module, configured to obtain a coupled meteorological factor index according to the acquired meteorological data;

an influence factor matrix acquiring module, configured to obtain an influence factor matrix according to coupled meteorological index data;

a basic state matrix acquiring module, configured to obtain a basic state matrix according to the active load data;

an augmented data source matrix acquiring module, configured to obtain an augmented data source matrix according to the basic state matrix and the influence factor matrix;

a Pearson correlation coefficient matrix acquiring module, configured to obtain a Pearson correlation coefficient matrix by calculating Pearson correlation coefficients of the coupled meteorological factor index and the active load data in the augmented data source matrix;

a source matrix acquiring module, configured to obtain a source matrix according to the Pearson correlation coefficient matrix and the basic state matrix;

a random matrix acquiring module, configured to obtain the random matrix after performing matrix transformation on the source matrix; and

a data abnormality recognition module, configured to obtain probability density distribution after performing spectrum analysis on characteristic values of the random matrix, and obtain an abnormality recognition result of the active load data according to comparison between the probability density distribution and historical probability density distribution in a normal state.

Compared with the prior art, the beneficial effects of the present application are as follows:

Firstly, the method and system of the present application generate the coupled meteorological factor index according to the collected meteorological data, and calculate the Pearson correlation coefficient of power data collected by a power grid measurement system and the coupled meteorological factor index, and the Pearson correlation coefficient can sensitively reflect whether the change trend between the abnormal active power data and influence factors is the same. Therefore, if there are different active power abnormal data in the state of similar influence factors, the Pearson correlation coefficient will change significantly, and correspondingly the random matrix model has a more distorted characteristic value distribution, providing a better recognition effect, and greatly improving the accuracy in recognizing the abnormal data of the active load.

Secondly, the method and system of the present application combine the Pearson correlation coefficient with the random matrix model, and use linear characteristic values and Pearson correlation coefficients as quantitative indexes, to realize an effective combination of visualization and quantification of correlation, providing an important basis for accurate measurement of the load.

Thirdly, compared with other Big data processing methods, the method and system of the present application can merge high-dimensional and heterogenous power data to realize fast real-time calculation and analysis of data. The real-time window translation method applied can fully consider the cumulative effect, and a data block selected during window translation contains a large amount of previous data, which can realize the efficient use of data and avoid the problem that the amount of data in the power system continues to increase but the data utilization rate is low.

### BRIEF DESCRIPTION OF THE DRAWINGS

The accompanying drawings constituting a part of the present application are used to provide a further understanding of the present application. The exemplary examples of the present application and descriptions thereof are used to explain the present application, and do not constitute an improper limitation of the present application.

FIG. 1 is a schematic flow chart of a method for analyzing a regional energy Internet load behavior based on a random matrix provided in Example 1 of the present application.

FIG. 2 is a schematic diagram of a correlation analysis framework provided by Example 1 of the present application.

FIG. 3 is a schematic diagram of construction of a random matrix model provided in Example 1 of the present application.

FIG. 4 is a schematic flow chart of matrix transformation provided in Example 1 of the present application.

### DETAILED DESCRIPTION

The present application is further described below with reference to the accompanying drawings and embodiments.

It should be pointed out that the following detailed descriptions are all illustrative and are intended to provide further descriptions of the present application. Unless otherwise specified, all technical and scientific terms used herein have the same meanings as those usually understood by a person of ordinary skill in the art to which the present application belongs.

It should be noted that the terms used herein are merely used for describing specific implementations, and are not intended to limit exemplary implementations of the present application. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

The embodiments in the present application and features in the embodiments may be mutually combined in case that no conflict occurs.

### Example 1

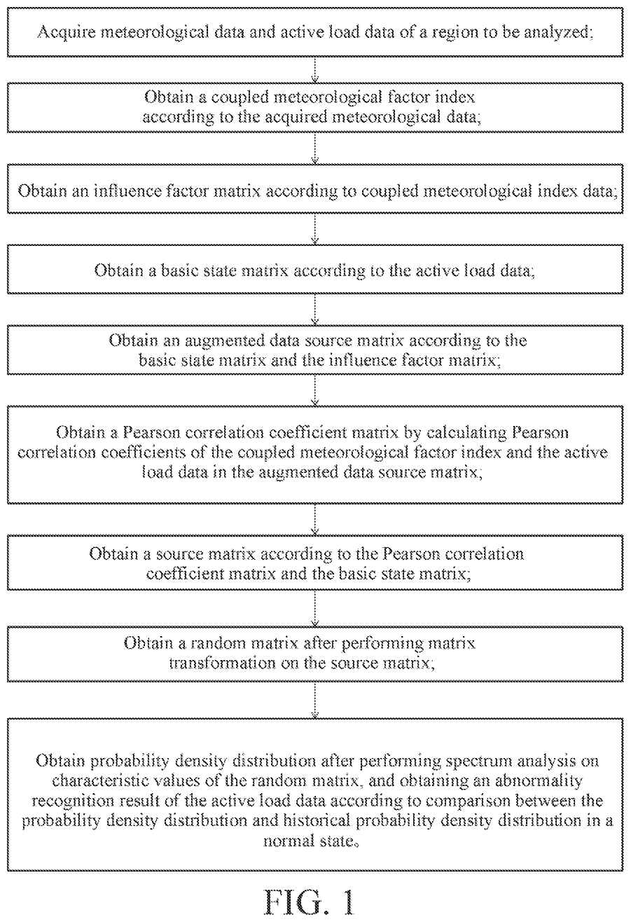

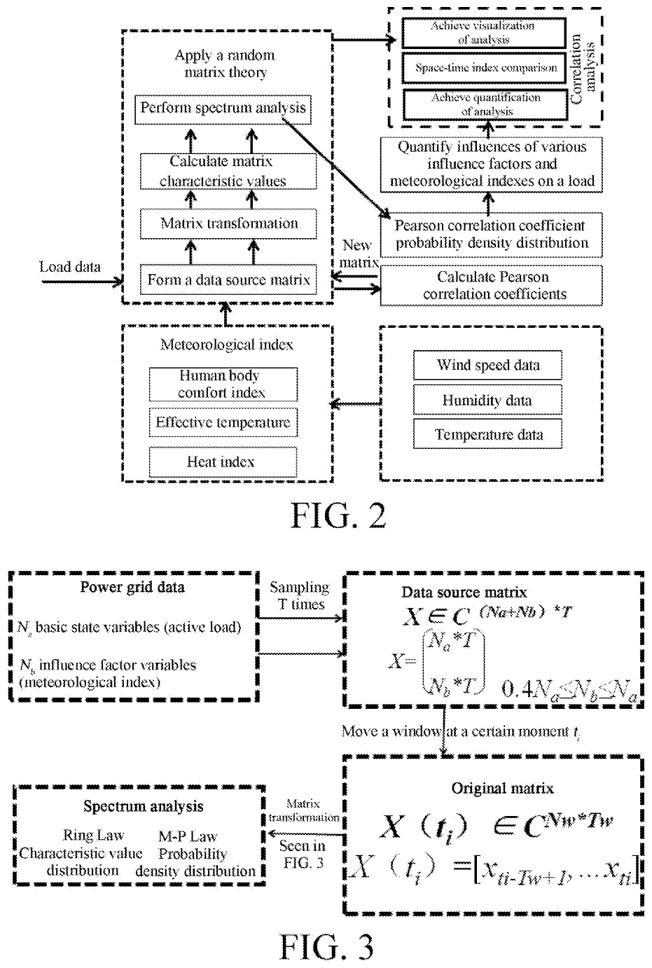

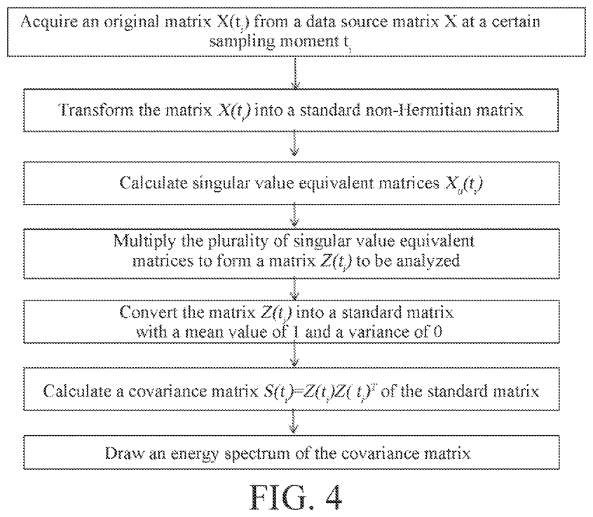

As shown in FIG. 1, FIG. 2, FIG. 3 and FIG. 4, Example 1 of the present application provides a method for analyzing a regional energy Internet load behavior based on a random matrix, comprising the following process:

acquiring meteorological data and active load data of a region to be analyzed;

obtaining a coupled meteorological factor index according to the acquired meteorological data;

obtaining an influence factor matrix according to coupled meteorological index data;

obtaining a basic state matrix according to the active load data;

obtaining an augmented data source matrix according to the basic state matrix and the influence factor matrix;

obtaining a Pearson correlation coefficient matrix by calculating Pearson correlation coefficients of the coupled meteorological factor index and the active load data in the augmented data source matrix;

obtaining a source matrix according to the Pearson correlation coefficient matrix and the basic state matrix;
obtaining the random matrix after performing matrix transformation on the source matrix; and

obtaining probability density distribution after performing spectrum analysis on characteristic values of the random matrix, and obtaining an abnormality recognition result of the active load data according to comparison between the probability density distribution and historical probability density distribution in a normal state.

In this example, the coupled meteorological index data includes:

(1) Heat Index

The heat index can comprehensively reflect the coupling effect of two single meteorological factors, temperature and relative humidity, on the perceived temperature of a human body. The coupling effect of temperature and humidity is not a simple superposition. When the air temperature is moderate, the change of the relative humidity has less influence on the temperature actually perceived by the human body. When the temperature is high or low, especially in summer and winter, the change of the relative humidity has greater influence on the temperature actually perceived by the human body. The present application focuses on the high temperature season, and uses the heat index to complete the correction on a temperature index by the relative humidity.

A formula for calculating the heat index is:

HI=c₁+c₂T+c₃R+c₄TR+c₅T²+c₆R²+c₇T²R+c₈TR²+c₉T²R²,

wherein c₁=−42.38, c₂=2.049, c₃=10.14, c₄=−0.2248, c₅=−6.838*10−, c₆=−5.482*10⁻², c₇=1.228*10⁻³, c₈=8.528*10⁻⁴, c₉=−1.99*10⁻⁶. The application conditions of formula (1) are that the temperature should be greater than 80 degrees Fahrenheit, that is, 27 degrees Celsius, and the relative humidity should be greater than 40%.

(2) Effective Temperature

Effective temperature refers to a thermal sensation index produced by the human body under different air temperature, humidity and wind speed conditions, and is the manifestation of the coupling effect of three single meteorological factors. In the calculation, the effective temperature is based on the static saturated atmospheric conditions, that is, the temperature at which the human body feels comfortable under the condition that the wind speed is zero and the relative humidity reaches 100% is used to represent different sensible temperatures under the conditions of different wind speeds, different relative humidity and different air temperatures.

A calculating formula is:

$${T}_{e} = 37 - \frac{( 37 - {T}_{a} )}{[ 0.68 - 0.14 {R}_{h} + 1 / 1.76 + 1.4 {V}^{0.75} ) ]} - 0.29 {T}_{a} ( 1 - {R}_{h} ) , \qquad ( 2 )$$

wherein Tₑ, Tₐ, Rₕ, and V correspond to the effective temperature, the air temperature, the relative humidity and the wind speed, respectively.

(3) Human Body Comfort Index

Human body comfort index measures the coupling effect of three single meteorological factors, the temperature, the relative humidity and the wind speed on the human body, and is used to characterize the comfort level of the human body in the atmospheric environment.

A calculating formula is:

k=1.8Tₐ−0.55(1.8Tₐ−26)(1−Rₕ)−3.2\sqrt{V}+3.2 (3).

As shown in FIG. 2, in this example, the random matrix theory and the Pearson correlation coefficient are effectively combined to complete the visualization and quantification of correlation analysis. The random matrix can handle large-scale and various types of data. In order to analyze the impact of different types of data on the power system, this example constructs the augmented data source matrix for correlation research.

The augmented data source matrix consists of two parts, namely the basic state matrix and the influence factor matrix. For an n-node system, at a certain moment of ti, each node collects k state variables, and then n nodes obtain N measurement data, wherein N=n*k.

The specific realization process is:

(1) Respectively acquiring power grid data and meteorological data of two cities with different meteorological conditions.

(2) Calculating the coupled meteorological index according to the plurality of single meteorological factors, using the load data as basic state matrix data, using the coupled meteorological index data as influence factor matrix data, and forming the augmented data source matrix, thereby forming a random matrix model, and as shown in FIG. 3, the matrix transformation flow therein is as shown in FIG. 4.

Specifically, according to the same sampling time node (e. G. 96 nodes, i. E. sampling power grid state data and climate influence factor data once in 15 minutes, the power grid state data comprising data such as voltage, current and active load, and the climate influence factor data comprising temperature, humidity and the like), the coupled meteorological index data (such as the human body comfort index and other data mentioned in this example) calculated from the power grid state data and basic meteorological factor data such as temperature and humidity is longitudinally listed to obtain the augmented data source matrix, which is then converted into the independent and identically distributed random matrix through data processing shown in FIG. 3, and the advantages that the random matrix accommodates data in flexible and various types and a heterogeneous performance is good are made full use of.

The augmented data source matrix is divided into two main parts: the basic state matrix and the influence factor matrix. The basic state matrix is obtained from a power grid measurement terminal, and the influence factor matrix is obtained from the coupled factor index data obtained from the calculation of multiple single meteorological factor indexes.

In this example, the basic state matrix takes time points as the number of columns, data of a basic state quantity of a power grid represents the number of rows, and preferably, a dimension of 160*160 is used.

The influence factor matrix also takes time points as the number of columns and the coupled meteorological index data represents the number of rows.

In order to effectively reflect the influence of influence factors on the power grid state, when constructing the augmented data source matrix, it should be noted that the ratio c₁ between the dimension of influence factor variables and the dimension of basic state variables should be maintained between 0.4 and 1. If the number of collected influence factors is small, collected data should be copied until the limit requirement of the dimension ratio is met.

When the number of the dimension of the random matrix tends to infinity and the row-column ratio c is constant, the empirical spectrum distribution of the characteristic values will converge to the theoretical characteristics according to a random matrix theory. However, in practical applications, rather accurate asymptotic convergence results can also be observed as long as the dimensions of the matrix are relatively moderate, for example, tens to hundreds, which is the theoretical basis for applying the random matrix theory to power system analysis.

Specifically, the effectiveness of an abnormal data recognition method provided in this example is expressed by comparing the data density distribution in the normal steady state with the data density distribution in the abnormal state.

Expression of the density distribution is based on an M-P theory and a Ring Law theory, which is two visualization forms of matrix characteristic value distribution, and the two theories can verify each other.

The random matrix theory is specifically that: when the power system state is stable, data satisfy random distribution, and matrix characteristic value distribution is regular and stable.

First, expression of an M-P law: during stabilization, the data density distribution shall be consistent with the theoretical distribution as shown in Equation (6), such as the time to reach a wave peak and a wave peak amplitude, the degree of a curve decline and time shall be consistent.

Expression of the Ring Law theory: in normal distribution, the characteristic values shall be distributed between an inner ring and an outer ring, and the mean spectral radius (the mean value of the matrix characteristic value and the distance from the center of a circle in a complex plane) is generally between 0.7 and 0.8.

If abnormality occurs, for the M-P law: a waveform is distorted, the peak amplitude is decreased greatly, and after the peak appearance time is delayed, and the declining degree of a curve increases. For a Ring Law: the matrix characteristic values are concentrated in the inner ring, and the average spectral radius decreases obviously, generally around 0.4.

Specifically, the M-P law (Marchenko-Pastur law) in FIG. 3 is specifically:

assuming \tilde{X} as a non-Hermitian feature random matrix, each element is an independent and identically distributed random variable, and its elements satisfy:

μ(xᵢ)=0,σ²(xᵢ)=constant<∞ (4).

The covariance matrix is defined as:

$$S = \frac{1}{N} {XX}^{T} \qquad ( 5 )$$

After matrix transformation, the energy spectrum distribution of the covariance matrix is:

$${f}_{MP} ( {λ}_{S} ) = \{ \begin{matrix}\frac{1}{2 π cd {λ}_{s}} \sqrt{( b - {λ}_{S} ) ( {λ}_{S} - a )} & a \leq {λ}_{S} \leq b \\ 0 & otherwise\end{matrix} , \qquad ( 6 )$$

wherein λ_{S} is the characteristic value of the matrix, and c is the ratio of the row and column dimensions of the matrix, and should be between 0 and 1, a=d(1−\sqrt{c})², b=d (1+\sqrt{c})².

The Ring Law in FIG. 3 is specifically:

assuming \tilde{X} as a non-Hermitian feature random matrix, each element is an independent and identically distributed random variable, and its elements satisfy:

μ(xᵢ)=0,σ²(xᵢ)=1 (7).

When the dimensions N and T of the matrix tend to infinity, and c=N/T remains the same, empirical spectrum distribution of characteristic values of a singular value equivalent matrix converges to a circular ring, and its probability density function is:

$$f ( {λ}_{\tilde{Z}} ) = \{ \begin{matrix}\frac{1}{π cL} {\vert {λ}_{\tilde{Z}} \vert}^{\frac{2}{L} - 2} & {( 1 - c )}^{\frac{L}{2}} \leq \vert {λ}_{\tilde{Z}} \vert \leq 1 \\ 0 & otherwise\end{matrix} , \qquad ( 8 )$$

wherein λ_{\tilde{Z}} is the matrix characteristic value, L is the cumulative number of singular value equivalent matrix, the inner radius of the circular ring is (1−c)^{L/2}, and the outer radius of the circular ring is 1.

The Pearson correlation coefficient in FIG. 3 is specifically:

The Pearson correlation coefficient is used to reflect statistical indexes of the degree of linear correlation between two variables, focusing more on the relationship between the change trend of one variable and the change trend of another variable, so as to accurately reflect the follow-up performance between two variables, it is represented by the symbol r_{pq}, and the value is limited from −1 to 1. The greater the absolute value of r_{pq}, the stronger the correlation. When r_{pq} is greater than 0, it indicates that the two variables are in positive correlation, and the change trends of the two variables are consistent. A larger r_{pq} indicates a better following characteristic. When r_{pq} is less than 0, the two variables are in negative correlation, and the change trends of the two variables are opposite.

A formula for calculating the Pearson Correlation Coefficient is:

$${r}_{pq} = \frac{n {\sum }_{t = 1}^{n} {x}_{p} ( t ) {x}_{q} ( t ) - {\sum }_{t = 1}^{n} {x}_{p} ( t ) {\sum }_{t = 1}^{n} {x}_{q} ( t )}{\sqrt{( n {\sum }_{t = 1}^{n} {x}_{p}^{2} ( t ) - {( {\sum }_{t = 1}^{n} {x}_{p} ( t ) )}^{2} ) ( n {\sum }_{t = 1}^{n} {x}_{p}^{2} ( t ) - {( {\sum }_{t = 1}^{n} {x}_{p} ( t ) )}^{2} )}} . \qquad ( 9 )$$

In this example, selecting a sub-matrix from the augmented data source matrix by moving a window, calculating the Pearson correlation coefficient by using data of a certain row of the basic state matrix and a corresponding row of the influence factor matrix, and obtaining Pearson correlation coefficients of a state matrix and an influence factor matrix in the sub-matrix after multiple calculations. When synthesizing the augmented data source matrix with the basic state matrix data, the number of columns of the Pearson correlation coefficient matrix is less than that of the basic state matrix, so it is necessary to copy the Pearson correlation coefficient matrix at this time; at the same time, when selecting the sub-matrix dimension, setting the sub-matrix dimension equal to about one-tenth of the dimension of the source matrix.

The method described in this example reveals and quantifies the correlation between the coupled meteorological factor and a power consumption behavior (namely, an active power load), and when applying a random matrix theory to analyze the correlation between the meteorological factors and the power consumer behavior, this example achieves an effective combination of actual measurement and simulation, and an effective combination of visualization and quantification.

In terms of visualization: a random augmented data source matrix model is constructed through collected power system data. After matrix transformation, for the standard matrix, real-time processing is achieved by using a window translation method, and a characteristic value distribution image of the matrix is finally obtained. According to this, the influence of different user power consumption behaviors caused by different meteorological conditions is obtained, that is, whether the collected data has abnormality can be determined, and the real-time positioning of abnormal data can be realized.

In this example, real-time processing of a translation window is to restart data processing of the matrix by taking a required time node as the last column of the matrix and taking data of a certain scale.

The characteristic value distribution image includes two types:

The first one is the Ring Law, the fixed radius of the outer ring is 1, and the radius of the inner ring is calculated according to the formula of the Ring Law; if the data are randomly distributed, therefore the power grid state is stable, and no large disturbance or fault occurs, then all the characteristic values should be distributed between the inner ring and the outer ring; if large disturbances or faults occur, they are concentrated inside the radius of the inner ring.

The second image is the M-P law, if it is in a normal state, distribution of the matrix characteristic values should be basically consistent with an image presented by substituting the data into the formula, and if it is in an abnormal state, there will be great difference (especially the wave peak).

The augmented data source matrix is composed of the basic state matrix and the influence factor matrix (the basic state matrix and the influence factor matrix are spliced up and down, the basic state matrix is on the upper portion, the influence factor matrix is on the lower portion, and a row number ratio of the influence factor matrix to the basic state matrix is about 0.4).

In terms of quantification: it is mainly used to mine the relationship between the data, and there are many types meteorological factors, including temperature, humidity, air pressure, wind speed, rainfall, sunshine, etc. Temperature, humidity and wind speed data are selected as the meteorological factors in this example; three meteorological indexes: the heat index, the effective temperature and the human body comfort index are calculated based on the data of the three basic meteorological factors; then the Pearson correlation coefficient between the three meteorological indexes and the load data is calculated; and finally, the Pearson correlation coefficient is taken as the influence factor to form the influence factor matrix, and forms the random matrix model with active load data in a corresponding region.

The method described in this example can realize the effective combination of visualization and quantification of correlation analysis, not only studies the influence of a single meteorological factor on the power system, but also considers the function of multiple single meteorological factors and the cumulative effect of the meteorological factors at the same time, and the method can perform load prediction without the guidance of a priori formula, so as to play a decision-making auxiliary support role for reasonable scheduling.

### Example 2

Example 2 of the present application provides a system for analyzing a regional energy Internet load behavior based on a random matrix, comprising:

a data acquiring module, configured to acquire meteorological data and active load data of a region to be analyzed;

a coupled meteorological index acquiring module, configured to obtain a coupled meteorological factor index according to the acquired meteorological data;

an influence factor matrix acquiring module, configured to obtain an influence factor matrix according to coupled meteorological index data;

a basic state matrix acquiring module, configured to obtain a basic state matrix according to the active load data;

an augmented data source matrix acquiring module, configured to obtain an augmented data source matrix according to the basic state matrix and the influence factor matrix;

a Pearson correlation coefficient matrix acquiring module, configured to obtain a Pearson correlation coefficient matrix by calculating Pearson correlation coefficients of the coupled meteorological factor index and the active load data in the augmented data source matrix;

a source matrix acquiring module, configured to obtain a source matrix according to the Pearson correlation coefficient matrix and the basic state matrix;

a random matrix acquiring module, configured to obtain the random matrix after performing matrix transformation on the source matrix; and

a data abnormality recognition module, configured to obtain probability density distribution after performing spectrum analysis on characteristic values of the random matrix, and obtain an abnormality recognition result of the active load data according to comparison between the probability density distribution and historical probability density distribution in a normal state.

An operating method of the system is the same as the method for analyzing the regional energy Internet load behavior based on the random matrix provided in Example 1 and will not be described in detail herein.

A person skilled in the art should understand that the embodiments of the present application may be provided as a method, a system, or a computer program product. Therefore, the present application may use a form of hardware embodiments, software embodiments, or embodiments with a combination of software and hardware. Moreover, the present application may use a form of a computer program product that is implemented on one or more computer-usable storage media (including but not limited to a magnetic disk storage, an optical storage, and the like) that include computer-usable program code.

The present application is described with reference to flowcharts and/or block diagrams of the method, device (system), and computer program product in the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided to a general-purpose computer, a dedicated computer, an embedded processor, or a processor of another programmable data processing apparatus to generate a machine, so that the instructions executed by the computer or the processor of the another programmable data processing apparatus generate an apparatus for implementing a specific function in one or more processes in the flowcharts and/or in one or more blocks in the block diagrams.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

A person skilled in the art may understand that all or some of the procedures of the methods of the foregoing embodiments may be implemented by a computer program instructing relevant hardware. The program may be stored in a computer-readable storage medium. When the program is executed, the procedures of the foregoing method embodiments may be implemented. The storage medium may be a magnetic disk, an optical disc, a read-only memory (ROM), a random access memory (RAM), or the like.

The above descriptions are merely preferred embodiments of the present application and are not intended to limit the present application. A person skilled in the art may make various alterations and variations to the present application. Any modification, equivalent replacement, or improvement made and the like within the spirit and principle of the present application shall fall within the protection scope of the present application.

What is claimed is:

1. A method for analyzing a regional energy Internet load behavior based on a random matrix, comprising the following process:
acquiring meteorological data and active load data of a region to be analyzed;
obtaining a coupled meteorological index according to the acquired meteorological data;
obtaining an influence factor matrix according to coupled meteorological index data;
obtaining a basic state matrix according to the active load data;
obtaining an augmented data source matrix according to the basic state matrix and the influence factor matrix;
obtaining a Pearson correlation coefficient matrix by calculating Pearson correlation coefficients of the coupled meteorological index and the active load data in the augmented data source matrix;
obtaining a source matrix according to the Pearson correlation coefficient matrix and the basic state matrix;
obtaining the random matrix after performing matrix transformation on the source matrix; and
obtaining probability density distribution after performing spectrum analysis on characteristic values of the random matrix, and obtaining an abnormality recognition result of the active load data according to comparison between the probability density distribution and historical probability density distribution in a normal state;
calculating the Pearson correlation coefficients, comprising:
the basic state matrix taking time points as the number of columns, and data of a basic state quantity of a power grid representing the number of rows;
the influence factor matrix taking time points as the number of columns, and the coupled meteorological index data representing the number of rows;
the augmented data source matrix being upper-lower splicing of the basic state matrix and the influence factor matrix, the basic state matrix being on the upper portion, and the influence factor matrix being on the lower portion; and
selecting a sub-matrix from the augmented data source matrix by moving a window, calculating the Pearson correlation coefficient by using data of a certain row of the basic state matrix and a corresponding row of the influence factor matrix, and obtaining Pearson correlation coefficients of a state matrix and an influence factor matrix in the sub-matrix after multiple calculations.

2. The method for analyzing the regional energy Internet load behavior based on the random matrix according to claim 1, wherein
the matrix transformation comprises the following process:
acquiring a source matrix at a certain sampling moment;
transforming the source matrix into a standard non-Hermitian matrix;
according to the obtained standard non-Hermitian matrix, calculating singular value equivalent matrices;
multiplying the plurality of obtained singular value equivalent matrices to obtain a matrix to be analyzed;
converting the matrix to be analyzed into a standard matrix with a mean value of 1 and a variance of 0; and
using a covariance matrix of the standard matrix as a finally transformed matrix.

3. The method for analyzing the regional energy Internet load behavior based on the random matrix according to claim 1, wherein
characteristic values of a matrix after matrix transformation are calculated;
spectrum analysis according to the obtained characteristic values is performed;
probability density distribution of the Pearson correlation coefficient according to spectrum analysis results is obtained; and
a correspondence between the coupled meteorological factor index and the active load data according to the probability density distribution of the Pearson correlation coefficient is obtained.

4. The method for analyzing the regional energy Internet load behavior based on the random matrix according to claim 1, wherein
a row number ratio of the influence factor matrix to the basic state matrix is 0.4.

5. The method for analyzing the regional energy Internet load behavior based on the random matrix according to claim 1, wherein
the coupled meteorological factor index at least comprises a heat index (HI):
HI=c₁+c₂T+c₃R+c₄TR+c₅T²+c₆R²+c₇T²R+c₈TR²+c₉T²R²
wherein c₁, c₂, c₃, c₄, c₅, c₆, c₇, c₈ and c₉ are constant coefficients, T is temperature and R is relative humidity.

6. The method for analyzing the regional energy Internet load behavior based on the random matrix according to claim 1, wherein
the coupled meteorological factor index at least comprises an effective temperature Tₑ:
$${T}_{e} = 37 - \frac{( 37 - {T}_{a} )}{[ 0.68 - 0.14 {R}_{h} + 1 / 1.76 + 1.4 {V}^{0.75} ) ]} - 0.29 {T}_{a} ( 1 - {R}_{h} )$$
wherein, Tₐ is an air temperature, Rₕ is the relative humidity, and V is a wind speed.

7. The method for analyzing the regional energy Internet load behavior based on the random matrix according to claim 1, wherein
the coupled meteorological factor index at least comprises a human body comfort index k:
k=1.8Tₐ−0.55(1.8Tₐ−26)(1−Rₕ)−3.21\sqrt{V}+3.2
wherein, Tₐ is an air temperature, Rₕ is the relative humidity, and V is a wind speed.

8. A system for analyzing a regional energy Internet load behavior based on a random matrix, comprising:
a data acquiring module, configured to acquire meteorological data and active load data of a region to be analyzed;
a coupled meteorological index acquiring module, configured to obtain a coupled meteorological factor index according to the acquired meteorological data;
an influence factor matrix acquiring module, configured to obtain an influence factor matrix according to coupled meteorological index data;
a basic state matrix acquiring module, configured to obtain a basic state matrix according to the active load data;
an augmented data source matrix acquiring module, configured to obtain an augmented data source matrix according to the basic state matrix and the influence factor matrix;
a Pearson correlation coefficient matrix acquiring module, configured to obtain a Pearson correlation coefficient matrix by calculating Pearson correlation coefficients of the coupled meteorological factor index and the active load data in the augmented data source matrix;
a source matrix acquiring module, configured to obtain a source matrix according to the Pearson correlation coefficient matrix and the basic state matrix;
a random matrix acquiring module, configured to obtain the random matrix after performing matrix transformation on the source matrix; and
a data abnormality recognition module, configured to obtain probability density distribution after performing spectrum analysis on characteristic values of the random matrix, and obtain an abnormality recognition result of the active load data according to comparison between the probability density distribution and historical probability density distribution in a normal state;
calculating the Pearson correlation coefficients, comprising:
the basic state matrix taking time points as the number of columns, and data of a basic state quantity of a power grid representing the number of rows;
the influence factor matrix taking time points as the number of columns, and the coupled meteorological index data representing the number of rows;
the augmented data source matrix being upper-lower splicing of the basic state matrix and the influence factor matrix, the basic state matrix being on the upper portion, and the influence factor matrix being on the lower portion; and
selecting a sub-matrix from the augmented data source matrix by moving a window, calculating the Pearson correlation coefficient by using data of a certain row of the basic state matrix and a corresponding row of the influence factor matrix, and obtaining Pearson correlation coefficients of a state matrix and an influence factor matrix in the sub-matrix after multiple calculations.
